(19) United States
(12) Patent Application Publication
(10) Pub. No.: US 2025/0146959 A1
(43) Pub. Date: May 8, 2025

(54) FIDUCIALS FOR X-RAY DEVICE

(71) Applicant: Lumafield, Inc., Cambridge, MA (US)

(72) Inventors: Adam P. Damiano, Somerville, MA (US); Kevin David Cedrone, Boxborough, MA (US); Elizabeth Mittmann, Cambridge, MA (US); Andreas Linas Bastian, San Francisco, CA (US)

(21) Appl. No.: 18/938,422

(22) Filed: Nov. 6, 2024

Related U.S. Application Data
(60) Provisional application No. 63/597,221, filed on Nov. 8, 2023.

(51) Int. Cl. G01N 23/046

(52) U.S. Cl. CPC G01N 23/046; G01N 2223/303; G01N 2223/401; G01N 2223/505

(57) ABSTRACT

Provided herein are methods, apparatuses, computer program products, and systems for fiducials in X-ray devices. One device can include an X-ray source configured to emit X-rays; a scintillator configured to absorb, on a first side, the X-rays after interaction with a scan object, the scintillator being configured to emit light from a second side of the scintillator in response to absorption of the X-rays; a camera configured to receive the light from the second side of the scintillator; and at least one optical fiducial located on the second side of the scintillator and within a field-of-view of the camera, wherein each of the at least one optical fiducial includes a sharp feature, which causes an abrupt step change of intensity in reflected light, and an image captured by the camera includes data representing the sharp feature that is processable to characterize at least one optical parameter of the camera.

### CROSS-REFERENCE TO RELATED APPLICATIONS

This patent application claims priority to and the benefit of U.S. Provisional Patent Application Ser. No. 63/597,221, filed on Nov. 8, 2023, which is incorporated herein by reference in its entirety.

### BACKGROUND

This specification relates to X-ray devices, such as computed tomography (CT) devices.

X-ray devices can be used to detect defect(s) in and/or damage to an object without disassembling the object. For example, an X-ray CT scanner can be used by manufacturers to determine the quality of the products which they produce. X-ray devices are particularly useful to give manufacturers the ability to inspect certain parts of their products in a non-invasive, non-destructive fashion. Given this, X-ray devices are becoming more popular in production manufacturing settings where quality control is of high importance.

### SUMMARY

Some X-ray devices can have a decoupled X-ray detector where a scintillator is decoupled from a detector. Some decoupled X-ray detectors can include a scintillator configured to absorb the X-rays after the X-rays interact with an object and a camera configured to capture light photons emitted by the scintillator. However, one or more optical parameters of the system comprising the X-ray source, the object, and the camera can change over time, e.g., between scans, or while the X-ray device scans an object. In some implementations, the X-ray device can be an economic low-cost system using one or more low-cost materials holding the camera, the scintillator, and the X-ray source in place, and thus the X-ray device can be more susceptible to focus drift, optical geometry drift, etc. Sometimes, the focus of the camera can change over time, e.g., when the camera is exposed to cyclic temperatures or vibrations. Sometimes, the optical geometry of the camera can change. For example, the optical axis of the camera relative to the scintillator, the distance from the camera to the scintillator along the optical axis of the camera, or both, can change. The change of the one or more optical parameters of the camera can result in blurry scans (e.g., radiographs and/or reconstructed images that are blurry), scans with inaccurate spatial geometry, or other inaccuracies. Moreover, the scintillator of the X-ray device can sometimes cause blurriness in the scan beside blurriness introduced by the change of the one or more optical parameters of the camera. The X-ray spectrum and detector response can also change over time.

This specification describes technologies relating to one or more fiducials in an X-ray device, such as an X-ray device having a decoupled X-ray detector. An image of the one or more fiducials can be processed to characterize and/or calibrate the X-ray device. An optical fiducial can be attached to the scintillator on the side facing the camera. An image of the optical fiducial can be processed to characterize the focus of the camera, the optical geometry of the camera, or both. In some implementations, a scintillator blur fiducial can be attached to the scintillator on the side facing the X-ray source. An image of the scintillator blur fiducial can be processed to decompose contributions of blur introduced by the camera and blur introduced by the scintillator. In some implementations, a step wedge fiducial can be used to characterize change to the X-ray spectrum, detector response, or both. In some implementations, a step wedge fiducial with a sharp feature can double as a scintillator blur fiducial. In some implementations, one or more fiducials described above can be placed in a margin between the field-of-view of the camera and an area of the scintillator that is excited by the X-rays from the maximum scan volume of the X-ray device. Because the margin is not actively used to image a scan object, the one or more fiducials do not compromise the performance of the X-ray device.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a cross-sectional and schematic view of an example X-ray device.

FIG. 2 shows an example of fiducial placements.

FIG. 3 is a flowchart showing an example of a process to characterize optical parameters of a camera using an optical fiducial.

FIG. 4 is a flowchart showing an example of a process to characterize the focus of the camera using an optical fiducial.

FIG. 5 is a flowchart showing an example of a process to calibrate the focus of the camera using an optical fiducial.

FIG. 6 is a flowchart showing an example of a process to calibrate the optical geometry of the camera using an optical fiducial.

FIGS. 7A-7C are diagrams showing examples of a wavelength selective optical fiducial.

FIG. 8 is a flowchart showing an example of a process to characterize the scintillator blur using a scintillator blur fiducial.

FIG. 9 is a flowchart showing an example of a process to characterize a spectrum of the X-ray using a step wedge fiducial.

FIG. 10A shows an example image of optical fiducials.

FIG. 10B shows an example image of a step wedge fiducial and a scintillator blur fiducial.

Like reference numbers and designations in the various drawings indicate like elements.

### DETAILED DESCRIPTION

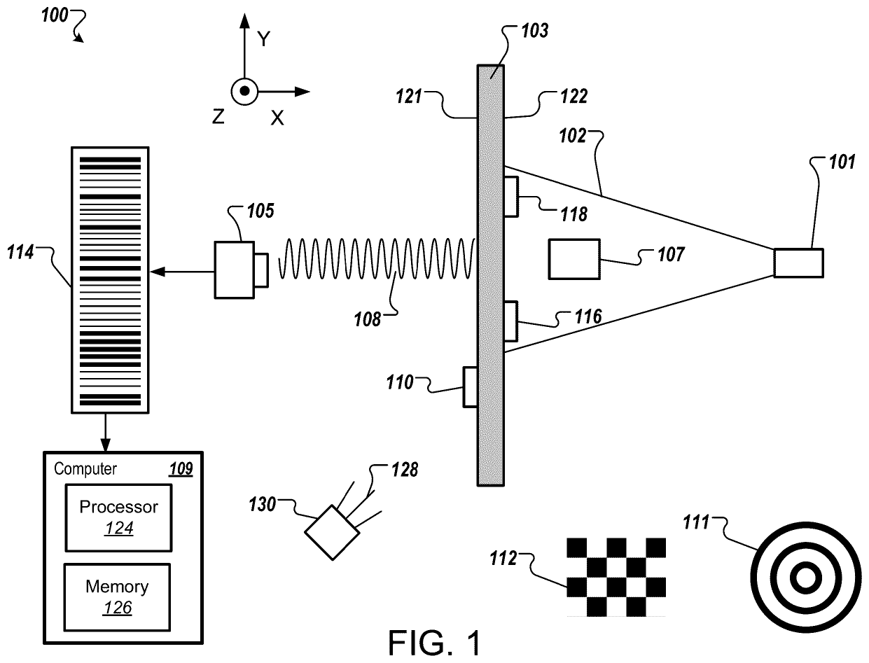

FIG. 1 shows a cross-sectional and schematic view of an example X-ray device 100. The X-ray device 100 includes X-ray source 101 configured to emit X-rays 102 towards a scintillator 103. As X-rays 102 pass through an object 107 that has been placed in the X-ray device 100 and collide with scintillator 103, the scintillator 103 absorbs the X-rays 102 and emits light 108. The camera 105 can detect the incoming light 108 and can be configured to generate an image (e.g., a radiograph) using the detected light. The X-ray device 100 can include a decoupled detector where the scintillator 103 is decoupled from the camera 105, instead of being physically attached to a detector.

The X-ray source 101 is an apparatus that emits X-ray radiation. The scintillator 103 can include a material that emits visible, ultraviolet, and/or infrared light when excited by X-ray radiation. The scintillator 103 can be configured to absorb, on a first side 122 of the scintillator, the X-rays 102 after the X-rays interact with the object 107. The scintillator 103 can be configured to emit light from a second side 121 of the scintillator in response to absorption of the X-rays 102.

The camera 105 can be an apparatus or device configured to receive and detect visible, ultraviolet, and/or infrared light. The camera 105 can have a field-of-view around an optical axis of the camera. The camera 105 can include an optical camera, a charge-coupled device (CCD) camera, a photodiode, or any combination of these. For example, an optical camera can include a complementary metal-oxide-semiconductor (CMOS) digital camera sensor. Alternatively, or additionally, an optical camera can include a red-green-green-blue (RGGB) Bayer filter and/or a monochromatic optical camera. In some implementations, an optical camera can include a back-side-illuminated sensor and/or front-side-illuminated sensor.

The camera 105 can be configured to generate an image (e.g., a radiograph) using detected light. In some implementations, the image can include an intensity and/or wavelength of light for each pixel. A computer, e.g., a computer 109, can be configured to receive the image and execute an algorithm for two-dimensional (2D) or three-dimensional (3D) reconstruction that uses the image (and optionally known information about the geometry of the arrangement of the scintillator 103 and the camera 105) to reconstruct a 2D or 3D model (e.g., a reconstructed image) of the object 107.

In some implementations, the X-ray device 100 can include a motion system configured to move, reposition, maneuver, or otherwise manipulate the camera 105, the object 107, the X-ray source 101, the scintillator 103, or a combination of these. In some implementations, the X-ray device 100 can include a mechanism, e.g., a mechanical mechanism, to adjust one or more optical parameters, e.g., a focus, optical geometry, binning, exposure duration, on-camera crop, or a combination of these, of the camera 105. For example, the focus of the camera can be adjusted by sending a movement command to a lens that has an integrated focus motor. As another example, for a lens with a manual focus, the focus of the camera can be adjusted by adjusting a ring gear affixed to the focus ring of the camera. In some implementations, the X-ray device 100 can include one or more mirrors (not illustrated in FIG. 1), e.g., folded optics, to reduce the optical path length and thus size of the X-ray device 100. Using the one or more mirrors to guide light 108 emitted by scintillator 103 into the camera 105 enables positioning of the camera 105 outside of the primary beam of X-ray radiation, which can reduce the chances that X-ray radiation will damage the camera 105 and thus increase the lifetime and performance of the camera 105.

One technical risk of a decoupled X-ray detector is that the focus of the camera may drift with time or when exposed to cyclic temperatures or vibrations. The X-ray device 100 includes at least one optical fiducial 110 located on the second side 121 of the scintillator 103 to characterize and/or calibrate the focus of the camera 105. Another technical risk of a decoupled X-ray detector is that the optical geometry of the camera assembly may change with respect to the scintillator or the distance from the camera to the scintillator along the optical axis of the camera may change. These changes may cause blurry scans or scans with incorrect spatial dimensions. The X-ray device 100 can correct the optical geometry inaccuracy using one or more optical fiducials 110 placed on or surrounding the scintillator. Thus, the X-ray device 100 can use the one or more optical fiducials 110 to characterize the focus of the camera, the optical geometry of the camera, or both.

For example, the X-ray device 100 can include, one, two, three, four or more optical fiducials. Each optical fiducial 110 can include a sharp feature, which can cause an abrupt step change of intensity in reflected light. For example, the optical fiducial 110 can cause an instantaneous step change of intensity in reflected light from high to low, or low to high, over a small spatial dimension (e.g., less than 1, 2 or 3 millimeters) and/or have little or no discernible gradient between low and high intensity in reflected light. Examples of optical fiducial 110 include a checkerboard pattern (e.g., a four by five checkerboard 112), a two-dimensional barcode such as a quick response (QR) code, a one-dimensional barcode, a circle array 111, or any suitable symbol of a symbology type that has an abrupt step change in reflectance. Barcodes inherently include abrupt step changes in reflectance needed to serve as an optical fiducial. In some implementations, a portion of a barcode can be used as an optical fiducial. For example, some of the lines in a 1D barcode can be too thin and may be not usable as an optical fiducial. The X-ray device 100 can determine to use one or more thicker lines of the 1D barcode as the optical fiducial. In some implementations, the barcode can encode information that can enable determining which portion of the barcode to use as the optical fiducial.

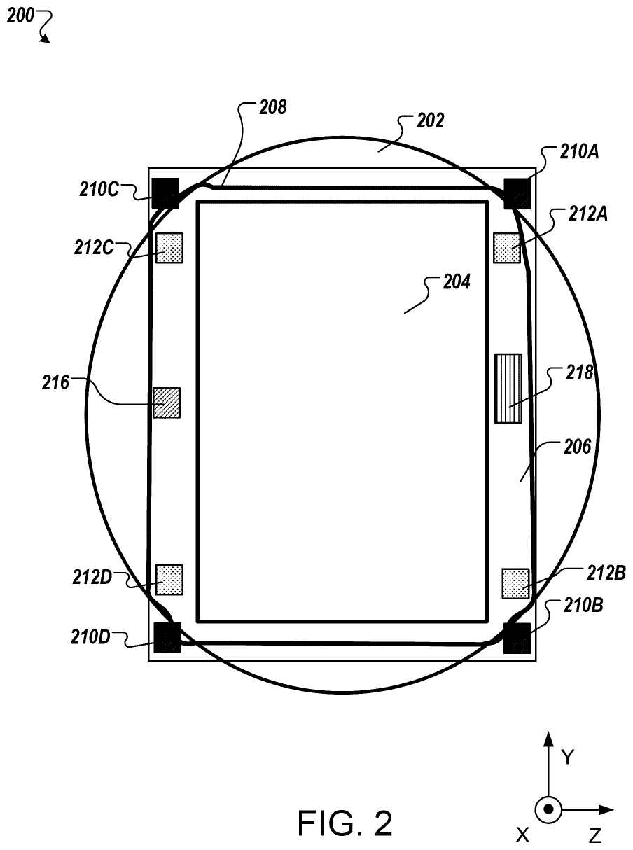

The at least one optical fiducial 110 is placed within the field-of-view of the camera 105. FIG. 2 shows an example 200 of fiducial placements. FIG. 2 shows an X-ray beam (e.g., an X-ray cone 202), a field-of-view 206 of the camera 105, an area 204 of the scintillator that is excited by the X-rays from a maximum scan volume of the X-ray device 100, and the boundary of the collimated X-ray 208 at the plane of the scintillator 103. The maximum scan volume is the maximum volume of an object that can be scanned and reconstructed using the X-ray device 100. The maximum scan volume can be determined based on the active area of the scintillator 103 that can emit light in response to absorption of the X-rays 102, the field-of-view 206 of the camera 105, and the size of the X-ray cone 202.

The optical fiducial 110 can be placed in a margin between the field-of-view of the camera and the area of the scintillator that is excited by the X-rays from the maximum scan volume. Because the margin is not actively used to image a scan object, the one or more fiducials do not compromise the performance of the X-ray device. In some implementations, the optical fiducial 110 can be placed outside the area 204 of the scintillator that is excited by the X-rays from the maximum scan volume of the X-ray device and within the field-of-view 206 of the camera 105. In some implementations, the optical fiducial 110 can be placed outside (or mostly outside) the boundary of the collimated X-ray 208 and within the field-of-view 206 of the camera 105. Thus, the light 108 emitted by the scintillator 103 in response to absorption of the X-rays 102 does not pass through the optical fiducial 110. For example, in FIG. 2, optical fiducials 210A, 210B, 210C, and 210D are placed at the four corners of the field-of-view of the camera 105. The optical fiducials 210A, 210B, 210C, and 210D, are within the field-of-view 206 of the camera 105, are mostly outside the boundary of the collimated X-ray 208, and are outside the area 204 of the X-ray device 100.

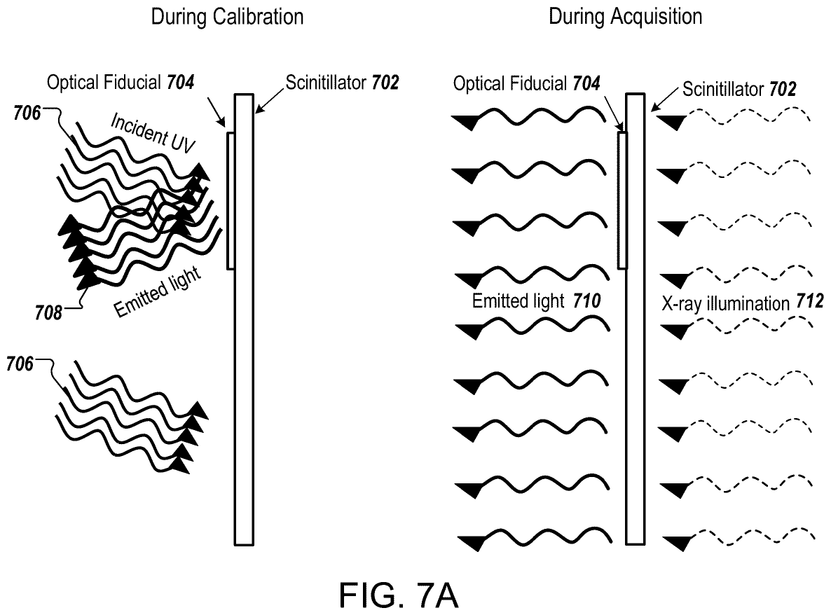

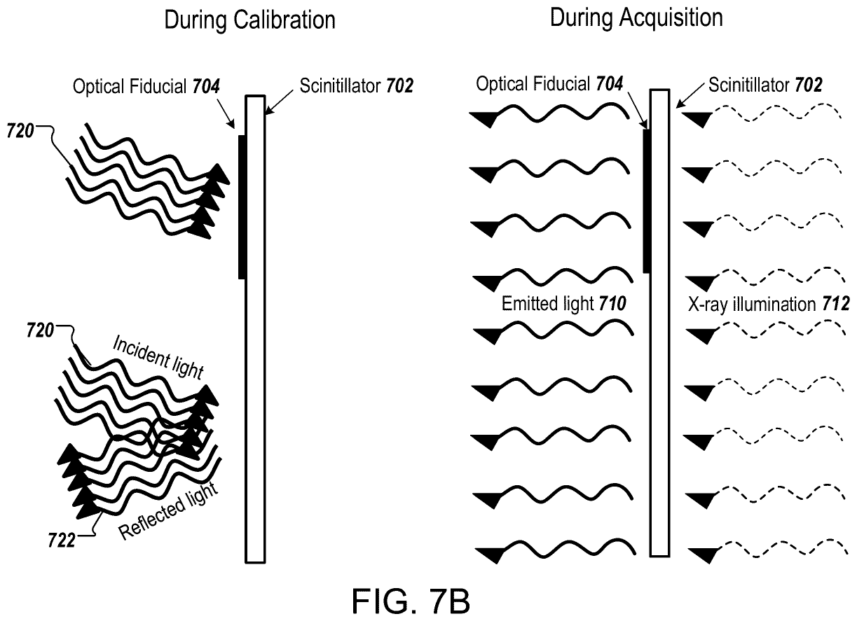

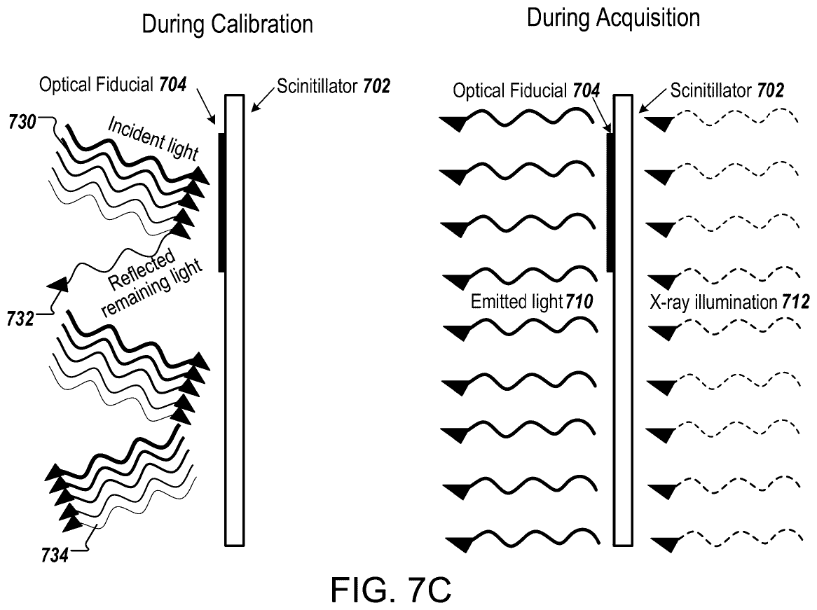

In some implementations, the optical fiducial 110 can be printed on the second side 121 (or printed on a substrate, which is then attached or adhered to the second side 121) of the scintillator 103 with a wavelength selective material and can be placed inside an area 204 of the scintillator that is excited by the X-rays from the maximum scan volume of the X-ray device 100. More details of wavelength selective optical fiducial are described below in connection with FIGS. 7A-7C.

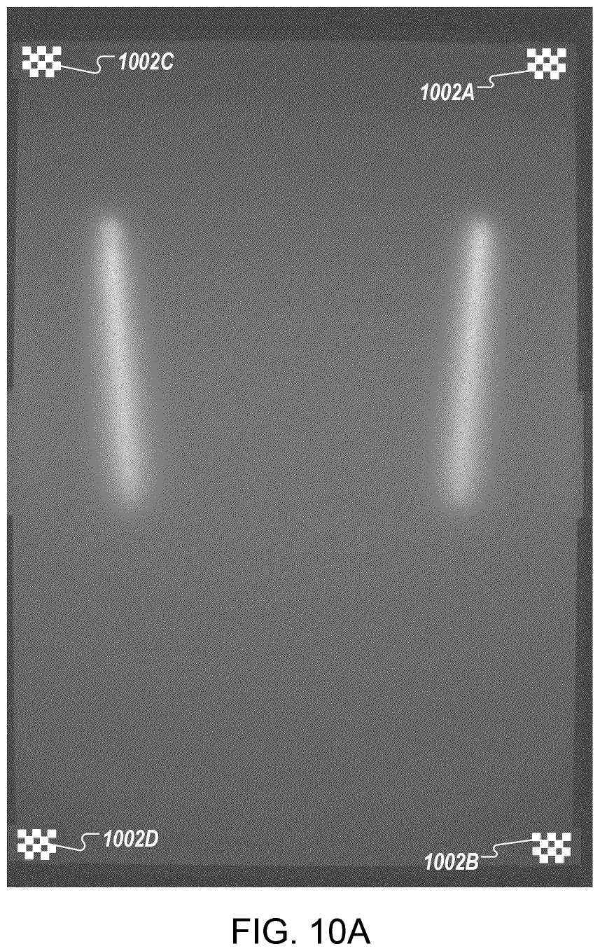

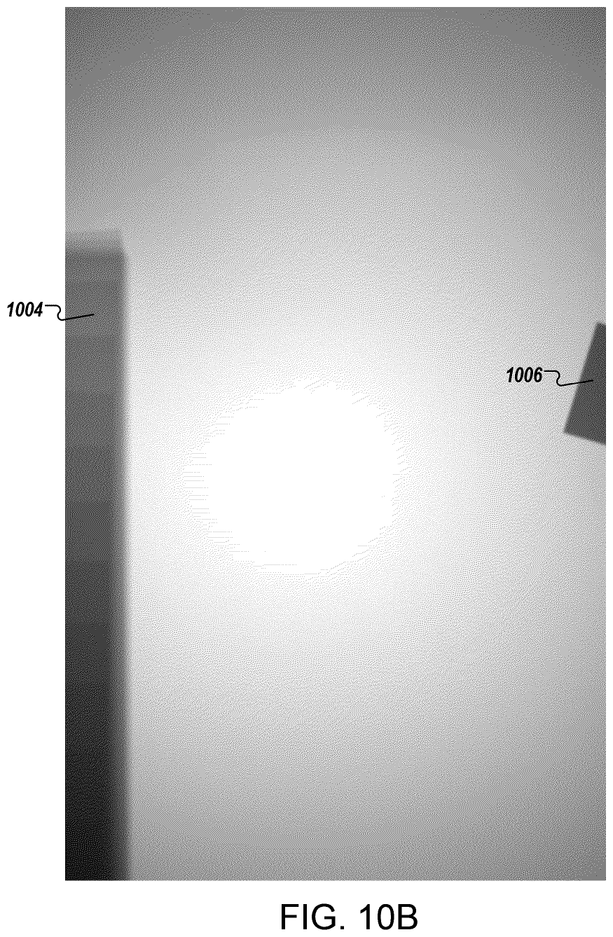

To use the optical fiducial, the X-ray device 100 can emit light inside the X-ray device 100, e.g., using a light source 130. In some implementations, the processor 124 can send a signal to the light source 130 to cause light emission inside the X-ray device 100. In some implementations, the light source 130 can be a light-emitting diode (LED) light source. For example, the light source 130 can be a LED strip which can provide a relatively uniform illumination. In some implementations, the light source 130 can be placed near the camera 105. In some implementations, if X-ray device 100 includes one or more mirrors to guide light emitted by the scintillator into the camera, the light source 130 can be placed near the camera pointing towards the mirror, or the light source 130 can be placed around the mirror pointing towards the scintillator. In some implementations, the light 128 emitted by the light source 130 can be white light. The camera 105 can detect reflected light from the optical fiducial 110 and can capture an image 114 that is processable to characterize the focus of the camera 105. The image 114 can include data representing the sharp feature of the at least one optical fiducial 110 and the data is processable to characterize at least one optical parameter of the camera 105, including the focus of the camera 105 at the plane of the scintillator 103. For example, the optical fiducial 110 can include a one or two dimensional barcode, and the image 114 captured by the camera 105 can include an image of the barcode, e.g., a blurred barcode. The image 114 is processable to characterize the focus of the camera 105, e.g., to verify whether the focus of the camera is optimized for CT analysis of radiographs. For example, FIG. 10A shows an example image of four optical fiducials 1002A, 1002B, 1002C, and 1002D, and each optical fiducial has a checkerboard 112.

A computer 109 processes the image 114 to characterize at least one optical parameter of the camera including the focus of the camera 105. The computer 109 can be one or more computers that are integrated with the camera 105, included in a detector assembly in the X-ray device 100, and/or located remotely from the X-ray device 100 (e.g., at a remote server and communicatively coupled with the X-ray device 100, e.g., over the Internet).

The computer 109 can include at least one processor 124. Processor(s) 124 can be embodied by any computational or data processing device, such as a central processing unit (CPU), application specific integrated circuit (ASIC), or comparable device. The processor(s) 124 can be implemented as a single controller, or a plurality of controllers or processors.

The computer can include at least one memory 126. The memory 126 can be fixed or removable. The memory 126 can encode computer program instructions or computer code contained therein. Memory 126 can be any suitable storage device, such as a non-transitory computer-readable medium. The term “non-transitory,” as used herein, can correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory can be used. The one or more memories can be combined on a same integrated circuit as one or more processors, or can be separate from the one or more processors. Furthermore, the computer program instructions stored in the memory, and which can be run by the processors, can be any suitable form of computer program code, for example, a compiled or interpreted computer program written in any suitable programming language.

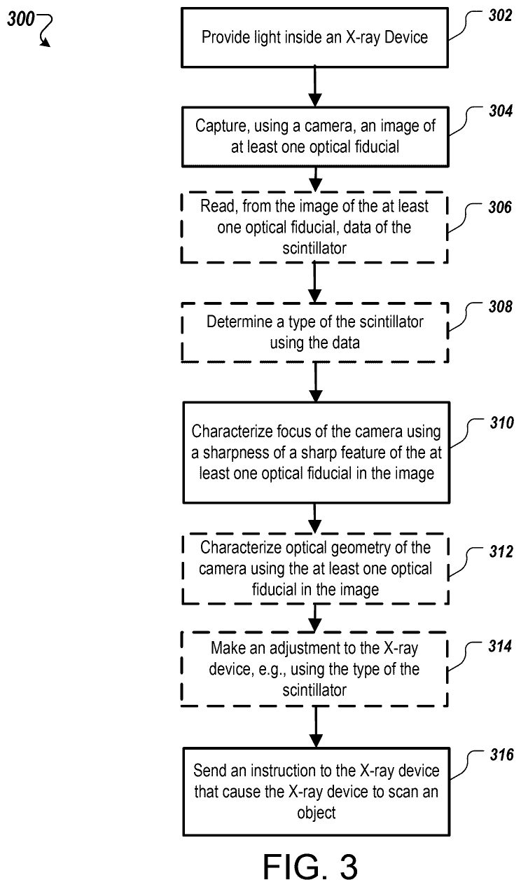

The processor 124, the memory 126, and any subset thereof, can be configured to provide the algorithmic functionality corresponding to the various blocks of FIGS. 3-6 and 8-9 in addition to being configured to provide CT object scanning and data acquisition functionality. The memory and the computer program instructions can be configured, with the processor for the particular device, to cause a hardware apparatus to perform one or more of the processes described in connection with FIGS. 3-9. Therefore, in some implementations, a non-transitory computer-readable medium is encoded with computer instructions that, when executed in hardware, perform a process such as one of the processes described herein. In some cases, one or more of the processes described herein are implemented entirely in hardware. As noted above, in some implementations, these processes can be performed by the X-ray device 100, and so no separate computer is needed. In such implementations, the computer 109 and the X-ray device 100 are integrated into a single device, rather than being in separate devices as shown in FIG. 1. In some implementations, the X-ray device 100 is an inexpensive scanning device with minimal processing capabilities, and a separate computer 109 is communicatively coupled with the X-ray device 100 and is configured to perform one or more of the processes described in connection with FIGS. 3-9.

In some implementations, the optical fiducial 110 can include a checkerboard 112 and the processor 124 can use an image processing library to grade the sharpness of an image (of the checkerboard pattern) captured by the camera 105. In some implementations, the optical fiducial 110 can include a symbol of a symbology type (e.g., a two-dimensional barcode such as a QR code or a one-dimensional barcode) that can encode data about the X-ray device. The data about the X-ray device can include scintillator type, lens model, camera model, scanner serial number and/or name, etc.

The X-ray device 100 and/or the processor 124 can calibrate the focus of the camera 105 using the at least one optical fiducial 110. The processor 124 can provide light inside the X-ray device 100. For example, the X-ray device 100 can emit light 128 inside the X-ray device. In some implementations, the processor 124 can send a signal to the light source 130 to cause light emission inside the X-ray device 100. The processor 124 can set the camera 105 to two or more different focuses and/or focus planes. For example, the processor 124 can sweep the lens focus of the camera 105 from the negative extreme to the positive extreme. The processor 124 can capture, using the camera 105, a respective image of the at least one optical fiducial 110 for each of the two or more different focuses. For example, the X-ray device 100 can capture an image at each lens focus. The processor 124 can determine a calibrated focus of the camera 105 that corresponds to an image with a sharpest sharp feature among the images captured for the two or more different focuses. For example, the processor 124 can determine sharpness of the optical fiducial 110 for each image and can determine the calibrated focus that corresponds to an image with the highest sharpness. The processor 124 can send the calibrated focus to the X-ray device 100. For example, the processor 124 can send an instruction to the camera 105 and the instruction can cause the lens of the camera to move to a position that creates the sharpest optical fiducial 110.

In some implementations, the at least one optical fiducial 110 can be used to correct for optical geometric changes, e.g., translation, rotation, scale, etc. In some implementations, the X-ray device 100 includes only one optical fiducial, and an image of the optical fiducial can be processed to correct for a translation in the optical geometry. In some implementations, the X-ray device 100 includes two or more optical fiducials, and an image of the two or more optical fiducials can be processed to correct for translation, rotation, and scale in the optical geometry. In some implementations, X-ray device 100 includes three or more optical fiducials, and an image of the three or more optical fiducials can be processed to correct for an affine transformation in the optical geometry. In some implementations, X-ray device 100 includes four or more optical fiducials, and an image of the four or more optical fiducials can be processed to correct for a projective and/or homographic transformation in the optical geometry. In some implementations, an image registration algorithm can be used, e.g., by the processor 124, to identify optical geometry changes, e.g., the translation using a best fit between an initial calibration image and a recent image. In some implementations, the image registration algorithm can be based on the initial known placement region of the one or more fiducials and/or known fiducial characteristics, such as one or more barcode standards. In some implementations, the one or more fiducials can be detected and read, e.g., by the processor 124, without an initial calibration image.

The X-ray device 100 and/or the processor 124, can calibrate the optical geometry of the camera 105 using the optical fiducial 110. The processor 124 can capture, using the camera 105, a current image of the at least one optical fiducial. For example, the processor 124 can send a signal to the light source 130 to cause light emission inside the X-ray device 100 and the processor 124 can capture an image of the at least one optical fiducial. The processor 124 can obtain a reference image of the at least one optical fiducial captured during factory calibration. The processor 124 can determine a transformation function, such that locations of the at least one optical fiducial in a transformed image of the current image under the transformation function can match the locations of the at least one optical fiducial in the reference image. For example, the processor 124 can compare the reference image of the optical fiducials 110 captured during factory calibration with the new image, and the processor 124 can identify a transformation vector that would cause the current fiducial locations in the image to accurately overlay onto the fiducial locations in the reference image. The processor 124 can apply the transformation function to a future image captured by the camera to implement the revised calibration.

Sometimes, changes to focus, optical geometry, or both, of the camera 105 may happen mid-scan, e.g., while capturing multiple 2D radiographs for a 3D scan of an object. The X-ray device 100 can characterize and/or calibrate the optical characteristics (e.g., focus and/or optical geometry) of the camera during factory calibration or after manufacturing (post sale), at a predetermined interval, in between scans, during a scan of an object, or a combination of these.

For example, the X-ray device 100 can capture multiple radiographs during a 3D scan of an object. Between capturing radiographs for the 3D scan of the object, the X-ray device 100 can momentarily turn on an internal light 128 and can capture an image 114 of the optical fiducial 110. The processor 124 can process the image 114 of the optical fiducial 110 to check whether the measured focus of the camera 105 has drifted. If the measured focus of the camera has drifted, the X-ray device can perform a calibration of the focus to correct the focus. The processor 124 can process the image 114 to determine a transformation, e.g., an affine transformation, and can apply the transformation to a future scan (e.g., a radiograph or a reconstructed image). After calibrating the focus and/or determining the transformation, the X-ray device can capture the next radiograph for the object using the camera.

In some implementations, the scintillator 103 can be swapped among a plurality of scintillators to change a property of the X-ray device 100. The X-ray device 100 can include a scintillator tracking fiducial to identify the scintillator that is currently being used in the X-ray device 100. The scintillator tracking fiducial can be a one or two dimensional barcode, e.g., a QR code, encoding information about the scintillator, e.g., the make and/or model of the scintillator. The scintillator tracking fiducial can be located outside an area of the scintillator that is excited by the X-rays from the maximum scan volume of the X-ray device, and within the field-of-view of the camera. For example, a scintillator tracking fiducial 216 can be placed slightly outside the area 204 and inside the camera field-of-view 206. The camera 105 can capture an image of the scintillator tracking fiducial, and the processor 124 can read the image of the scintillator tracking fiducial to identify the scintillator that is currently being used in the X-ray device. The processor 124 can optimize the performance of the X-ray device based on the scintillator that is currently being used. In some implementations, a scintillator blur fiducial can be used to estimate a point spread function of the scintillator. The point spread function of the scintillator can be used to process, e.g., deconvolve, the captured radiographs, and reconstructed images generated from the processed radiographs can have improved sharpness and/or improved fine feature resolvability. In some implementations, the at least one optical fiducial 110 can be located on the scintillator 103 that can be swappable among a plurality of scintillators to change a property of the X-ray device 100. In some implementations, the optical fiducial 110 can double as the scintillator tracking fiducial. The optical fiducial can include a two-dimensional barcode such as a QR code or a one-dimensional barcode that encodes information about the scintillator that is currently being used.

In some implementations, the at least one optical fiducial 110 can be located on a frame into which the scintillator is inserted. In some implementations, to ensure scintillator flatness and rigidity, the scintillator can be mounted to a frame, e.g., a sheet of carbon fiber. In some implementations, the material for the frame, e.g., a sheet of carbon fiber, can be a material that is more X-ray transparent than metals. In some implementations, the frame can be extended beyond the extents of the scintillator to provide space for fiducials and/or mounting points. In some implementations, if further rigidity is required, a second frame with a rigid material, e.g., a steel frame, can be attached to the frame, e.g., the sheet of the carbon fiber, to provide further mechanical reinforcement.

In some implementations, the X-ray device 100 can include two or more cameras. The X-ray device 100 can use the at least one optical fiducial 110 to calibrate the two or more cameras in relation to each other. Thus, the images captured by the two or more cameras can be better aligned. In some implementations, the processor 124 can select which portion(s) of an image generated by one camera or the other to use or use more. For example, if one of the cameras has a smaller edge spread function (ESF) in a region, the processor 124 can apply higher weight to image data generated by that camera in the region.

In some implementations, the optical fiducials can include two or more sharp edges with abrupt step change of intensity in reflected light, and an image of each sharp edge can be processed to measure a component of the focus of the camera, e.g., in a direction correlated to the direction of a step change in the edge. In some implementations, the optical fiducial 110 can include a first sharp feature including a first abrupt step change of intensity in reflected light, and a second sharp feature including a second abrupt step change of intensity in reflected light. The image captured by the camera 105 can include (i) data representing the first sharp feature that is processable to characterize a horizontal component of the focus of the camera, and (ii) data representing the second sharp feature that is processable to characterize a vertical component of the focus of the camera. For example, the optical fiducial 110 can include a checkerboard 112 or a two-dimensional barcode. The checkerboard 112 or the two-dimensional barcode includes horizontal edges and vertical edges. The processor 124 can process an image of the checkerboard 112 or the two-dimensional barcode to characterize a horizontal component of the focus of the camera and a vertical component of the focus of the camera.

In some implementations, the X-ray device 100 can include a scintillator blur fiducial 116 located on the scintillator on the side 122 facing the X-ray source. The scintillator blur fiducial 116 can have a sharp feature that has a size below a threshold. For example, the scintillator blur fiducial 116 can include one or more edges, or one or more thin wires of dense metals, such as copper, platinum, or tungsten. In some implementations, the sharp feature can have a size that is smaller than the size of the optical blur at least by a threshold ratio, e.g., 20 times smaller than the blur the device is trying to measure. For example, if the X-ray device is trying to measure blur of 100 μm, the optical fiducial can have a transition region that is 5 μm or smaller.

The scintillator blur fiducial 116 can be located outside an area of the scintillator that is excited by the X-rays from the maximum scan volume of the X-ray device, within the X-ray beam (e.g., an X-ray cone or an X-ray fan), and within the field-of-view of the camera. In some implementations, the scintillator blur fiducial 116 can be located inside the boundary of the collimated X-ray and outside the area of the scintillator that is excited by the X-rays from the maximum scan volume of the X-ray device. For example, in FIG. 2, four scintillator blur fiducials 212A, 212B, 212C, and 212D are placed at the four corners of the boundary of the collimated X-ray 208. The scintillator blur fiducials 212A, 212B, 212C, and 212D are within the field-of-view 206 of the camera 105, are within the X-ray cone 202, are inside the boundary of the collimated X-ray 208, and are outside the area 204 of the X-ray device 100.

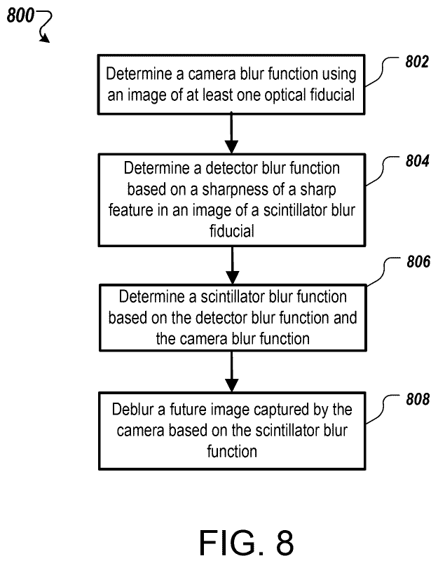

Referring to FIG. 1, an image of the scintillator blur fiducial 116 captured by the camera 105 includes data representing the sharp feature of the scintillator blur fiducial 116. For example, FIG. 10B shows an example image, e.g., a radiograph, of a scintillator blur fiducial 1006. The image of the scintillator blur fiducial is processable to characterize a scintillator blur function of the scintillator. For example, the X-ray device 100 can use the scintillator blur fiducial 116 to measure the point spread function or edge spread function of the detector assembly. The level of detector blur can be calculated by measuring the deviation of the imaged edge or wire from an ideal, sharp edge or wire, respectively. The image of the scintillator blur fiducial 116 is processable to characterize the point spread function or edge spread function of the detector assembly as a whole. Because the X-ray device 100 can use one or more optical fiducials 110 to characterize blur introduced by the camera, the X-ray device can decompose contributions of blur introduced by the camera and the blur introduced by the scintillator. More details of the scintillator blur fiducial are described below in connection with FIG. 8. In some implementations, the scintillator blur function can vary spatially in different regions of the scintillator, and the X-ray device 100 can use more than one scintillator blur fiducial, e.g., four scintillator blur fiducials 212A, 212B, 212C, and 212D as shown in FIG. 2, to characterize the blur in different regions of the scintillator. In some implementations, it can be useful to use more than one scintillator blur fiducial to obtain an average scintillator blur function over different regions of the scintillator.

In some implementations, the X-ray device 100 can include a step wedge fiducial 118 between the X-ray source and the scintillator, e.g., located on the scintillator on the side 122 facing the X-ray source. The step wedge fiducial 118 can be located outside an area of the scintillator that is excited by the X-rays from the maximum scan volume of the X-ray device, within the X-ray beam (e.g., an X-ray cone or an X-ray fan), and within the field-of-view of the camera. In some implementations, the step wedge fiducial 118 can be located inside the boundary of the collimated X-ray and outside the area of the scintillator that is excited by the X-rays from the maximum scan volume of the X-ray device. For example, in FIG. 2, a step wedge fiducial 218 is located on the scintillator. The step wedge fiducial 218 is within the field-of-view 206 of the camera 105, is inside the boundary of the collimated X-ray 208, is within the X-ray cone 202, and is outside the area 204 of the X-ray device 100.

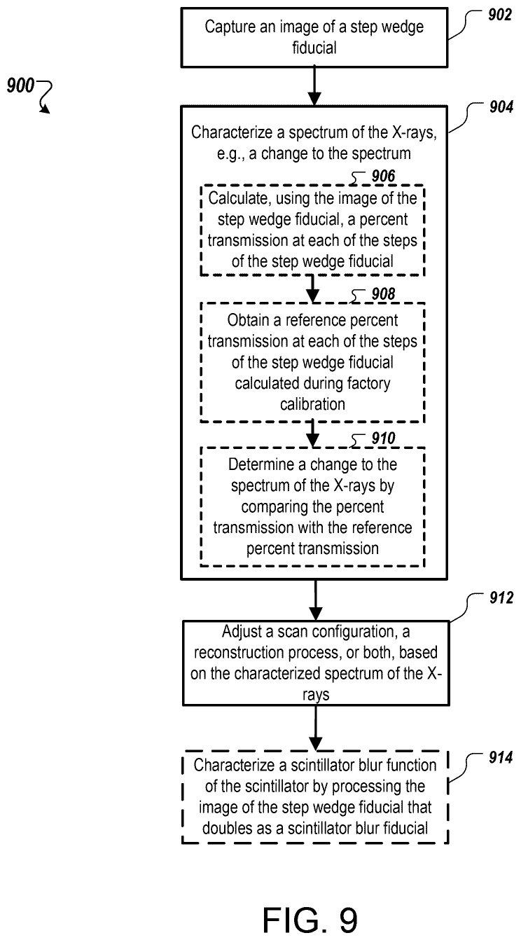

In general, a percent transmission of detected intensity of X-rays through a given material depends on the X-ray spectrum and the detector response. Referring to FIG. 1, the X-ray device 100 can use the step wedge fiducial 118 to detect changes to the X-ray spectrum, the detector response, or both, over a short period of time (e.g., over the course of a day) or over a long period of time (e.g., over the full lifetime of the scintillator). The step wedge fiducial 118 can include a wedge of a material with a plurality of steps in thickness. For example, a wedge of a material can have discrete steps in thickness instead of a gradual taper. Some possible materials for the step wedge fiducial can include copper, steel, etc. In some implementations, the material for the step wedge fiducial can be the same as the material of the object to be scanned by the X-ray device. For example, if the X-ray device is being used to scan parts made of steel, the step wedge fiducial can be made with steel. An image of the step wedge fiducial 118 captured by the camera 105 includes data representing the wedge with the plurality of steps of the step wedge fiducial. For example, FIG. 10B shows an example image e.g., a radiograph, of a step wedge fiducial 1004. The image of the step wedge fiducial 118 is processable to characterize a spectrum of the X-rays 102. For example, the processor 124 can calculate the percent transmission at each of the steps of the step wedge. The processor 124 can detect a deviation from percent transmission calculated during manufacturing of the X-ray device 100. The deviation can indicate changes to either the X-ray spectrum, detector response, or both. More details of the step wedge fiducial are described below in connection with FIG. 9.

FIG. 3 is a flowchart showing an example of a process 300 to characterize optical parameters of a camera using an optical fiducial. For example, the X-ray device 100 can include (or be communicatively coupled with) a non-transitory computer-readable medium, e.g., the memory 126, encoding instructions configured to cause a processor, e.g., the processor 124, to characterize the optical parameters of the camera 105.

Light is provided 302, e.g., by the processor 124, inside an X-ray device. For example, the X-ray device can include a light source 130 that emits light 128. An image of at least one optical fiducial is captured 304, e.g., by the processor 124, using a camera. In some implementations, data of the scintillator, can be read 306, e.g., by the processor 124, from the image of the at least one optical fiducial. In some implementations, a type of the scintillator can be determined 308, e.g., by the processor 124. In some implementations, other information of the X-ray device, such as lens model, camera model, scanner serial number/name, etc., can be determined by reading the image of the at least one optical fiducial.

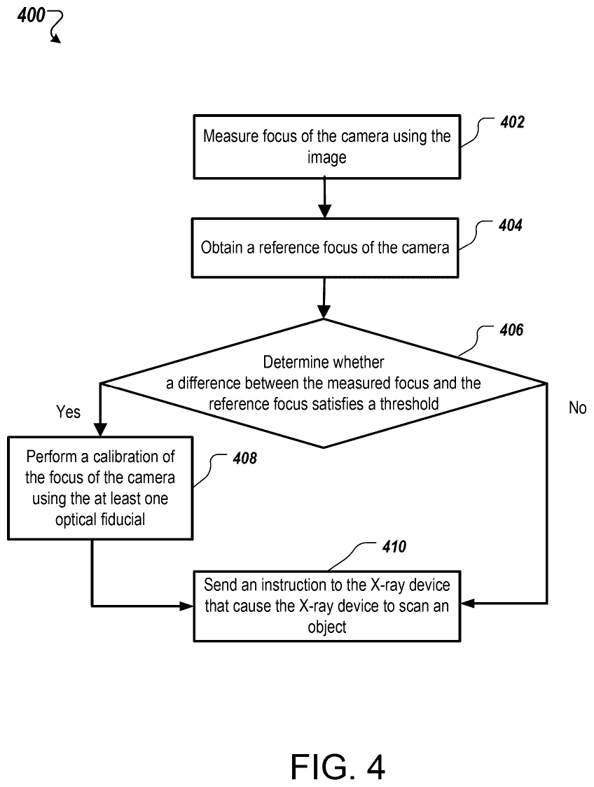

Focus of the camera is characterized 310, e.g., by the processor 124, using a sharpness of a sharp feature of the at least one optical fiducial in the image. More details of determining whether the camera is out of focus are described below in connection with FIG. 4. In some implementations, the camera can capture a plurality of images of the at least one optical fiducial over a period of time, e.g., over the course of a day or over the course of an object scan, and the processor 124 can characterize a change of the focus of the camera over the period of time based on the images of the at least one optical fiducial over the period of time.

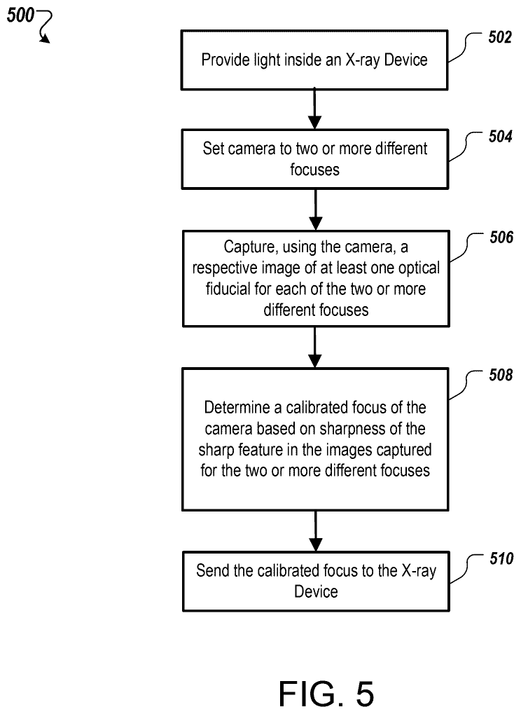

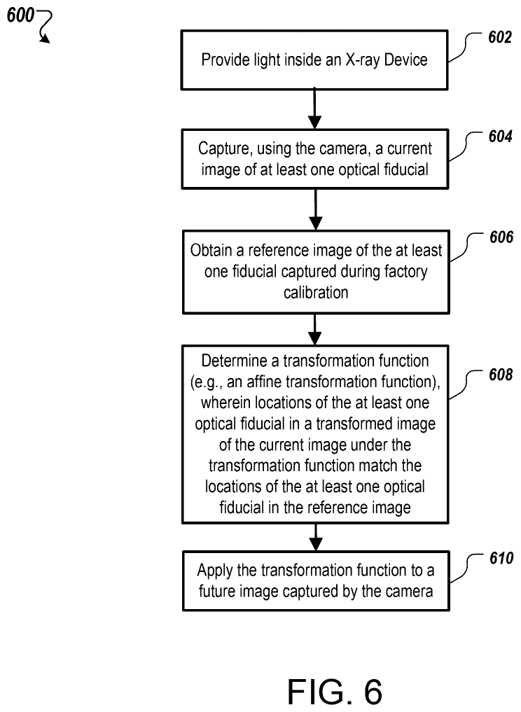

In some implementations, optical geometry of the camera can be characterized 312, e.g., by the processor 124, using the at least one optical fiducial in the image. In some implementations, an adjustment to the X-ray device can be made 314, e.g., by the processor 124. For example, the processor 124 can calibrate the focus and/or the optical geometry of the camera. In some implementations, the processor 124 can make the adjustment using the type of the scintillator, e.g., the type of the scintillator determined in operation 308. More details of calibration of the focus and optical geometry of the camera are described below in connection with FIG. 5 and FIG. 6, respectively.

An instruction can be sent 316, e.g., by the processor 124, to the X-ray device. The instruction can cause the X-ray device to scan an object, e.g., scan a next radiograph during a 3D scan of an object. The processor 124 can perform the characterization, calibration, and/or adjustments in between scans, or between scanning different views of the same object. After the characterization, calibration, and/or adjustments is completed, the X-ray device can perform the next scan or can scan the next view of the object.

FIG. 4 is a flowchart showing an example of a process 400 to characterize the focus of the camera using an optical fiducial. After capturing an image of at least one optical fiducial, e.g., operation 304, the focus of the camera is measured 402, e.g., by the processor 124, using the image. In some implementations, the processor 124 can determine a camera blur function using the measured focus of the camera. A reference focus of the camera is obtained 404, e.g., by the processor 124. The reference focus can be the focus of the camera measured during factory calibration. The reference focus can be measured by an optical fiducial that is the same or similar to the optical fiducial used in operation 304. Whether a difference between the measured focus and the reference focus satisfies a threshold is determined 406, e.g., by the processor 124. For example, the processor 124 can determine whether the difference between the measured focus and the reference focus is smaller than a threshold. The threshold can be a predetermined value.

If the difference between the measured focus and the reference focus does not satisfy the threshold, e.g., if the difference is not smaller than the threshold, a calibration of the focus of the camera can be performed 408, e.g., by the processor 124, using the at least one optical fiducial. More details of calibration of the focus of the camera are described below in connection with FIG. 5. In some implementations, if after the calibration of the focus of the camera, the difference between the measured focus and the reference focus still does not satisfy the threshold, the processor 124 can determine that a physical maintenance of the camera is required. The processor 124 can send a notification to a device or a computer and the notification can indicate that the X-ray device may need physical maintenance.

After completing the calibration of the focus, an instruction can be sent 410, e.g., by the processor 124, to the X-ray device, and the instruction can cause the X-ray device to scan an object. In some implementations, if the difference between the measured focus and the reference focus satisfies the threshold, e.g., if the difference is smaller than or equal to the threshold, the processor 124 can determine there is no need to perform calibration of the focus, and the processor 124 can proceed to operation 410 without further calibration.

FIG. 5 is a flowchart showing an example of a process 500 to calibrate the focus of the camera using an optical fiducial. Light is provided 502, e.g., by the processor 124, inside an X-ray device. A camera is set 504, e.g., by the processor 124, to two or more different focuses. A respective image of at least one optical fiducial for each of the two or more different focuses is captured 506, e.g., by the processor 124, using the camera. A calibrated focus of the camera is determined 508, e.g., by the processor 124, based on sharpness of the sharp feature in the images captured for the two or more different focuses. For example, the processor 124 can determine that the calibrated focus of the camera corresponds to an image with a sharpest sharp feature among the images captured for the two or more different focuses. As another example, the processor 124 can determine that the calibrated focus of the camera is a focus that is a linearly approximated focus point that is between two different focuses that provide the top two sharpest sharp feature. The calibrated focus is sent 510, by the processor 124, to the X-ray device.

FIG. 6 is a flowchart showing an example of a process 600 to calibrate the optical geometry of the camera using an optical fiducial. Light is provided 602, e.g., by the processor 124, inside an X-ray device. A current image of at least one optical fiducial is captured 604, e.g., by the processor 124, using the camera. A reference image of the at least one optical fiducial captured during factory calibration is obtained 606, e.g., by the processor 124. A transformation function is determined 608, e.g., by the processor 124, such that locations of the at least one optical fiducial in a transformed image of the current image under the transformation function match the locations of the at least one optical fiducial in the reference image. In some implementations, the at least one optical fiducial can include three optical fiducials, and the transformation function can be an affine transformation function (while only affine transformations are given as examples below, it will be appreciated that projective and/or homographic transformation using four or more optical fiducials, and translation, rotation, and/or scale transformations using one or two optical fiducials, are also possible in various implementations).

The transformation function is applied 610, e.g., by the processor 124, to a future image captured by the camera. For example, the processor 124 can determine an affine transformation based on the image of three or four optical fiducials, e.g., optical fiducials 210A, 210B, 210C, and 210D in FIG. 2, and can save the affine transformation in the memory 126. The X-ray device can perform a scan of a target object and can obtain a raw radiograph of the target object. The processor 124 can read the affine transformation from the memory 126 and can apply the affine transformation to the raw radiograph to generate a corrected radiograph. The processor 124 can generate a reconstructed image using the corrected radiograph.

In some implementations, the at least one optical fiducial 110 can be placed on the second side 121 of the scintillator 103 and can be formed using a wavelength selective material. In some implementations, the at least one optical fiducial 110 can be printed on the second side 121 (or printed on a substrate, which is then attached or adhered to the second side 121) of the scintillator 103 with a wavelength selective ink. For example, the at least one optical fiducial 110 can be printed on a film, e.g., a die or laser-cut adhesive-backed film, with a wavelength selective ink, and the film can be applied to the scintillator. FIGS. 7A-7C are diagrams showing examples of a wavelength selective optical fiducial, which can occupy the same space where the light emitted by the scintillator passes through.

In some implementations, as shown in FIG. 7A, the wavelength selective material can be a material that passes the light 710 emitted from the scintillator and emits light 708 when illuminated with ultraviolet (UV) light 706, and the second side of the scintillator does not emit light when illuminated with the UV light 706. For example, optical fiducials 704 (e.g., checkerboard, circle array) can be printed directly on to the scintillator with a visible light transparent, UV fluorescent ink. Because the ink is visible light transparent, during acquisition (e.g., performing a scan of an object), the emitted light 710 from the scintillator in response to X-ray illumination 712 can pass through the optical fiducial(s) 704. During calibration, the optical fiducials 704 can be illuminated with a UV light-emitting diode (LED) strip lighting in the X-ray device. The optical fiducials 704 with the UV fluorescent fiducial material can emit light 708 when illuminated with UV light 706, and the light emitted by the UV fluorescent fiducial material can produce light regions that can be imaged by the camera. Because the second side of the scintillator can use a material (e.g., gadolinium oxysulfide or Gadox) that does not emit light when illuminated with the UV light, a calibration pattern can be created on the scintillator surface and the pattern can be turned on and off while not interfering the scan acquisition. In some implementations, small differences in pixel gray value due to the UV ink can be removed via a flat-field correction (FFC) process.

In some implementations, as shown in FIG. 7B, the wavelength selective material can be a translucent material that passes an emission spectrum of the light 710 emitted from the scintillator 702, and an illumination 720 from a complementary color relative to the emission spectrum can be absorbed by the wavelength selective material and can be reflected by the second side of the scintillator 702. For example, optical fiducials 704 can be printed directly on to the scintillator 702 with a translucent ink that passes the emission spectrum (e.g., green) of the scintillator 702. Because the ink is a translucent ink that passes the emission spectrum of the scintillator, during acquisition, the emitted light 710 from the scintillator in response to X-ray illumination 712 can pass through the optical fiducial(s) 704. During calibration, illumination 720 from a complementary color (e.g., red) relative to the emission spectrum can be absorbed by the optical fiducials 704 and can be reflected by the scintillator (e.g., generating reflected light 722), creating a high contrast pattern that can be readily imaged by the camera.

In some implementations, as shown in FIG. 7C, the wavelength selective material can be a translucent material that passes an emission spectrum of the light emitted from the scintillator 702, and an illumination 730 from a white light source can be partially absorbed by the wavelength selective material and can be completely reflected by the second side of the scintillator 702. For example, optical fiducials 704 can be printed directly on to the scintillator 702 with a translucent ink that passes the emission spectrum (e.g., green) of the scintillator 702. Because the ink is a translucent ink that passes the emission spectrum of the scintillator, during acquisition, the emitted light 710 from the scintillator in response to X-ray illumination 712 can pass through the optical fiducial(s) 704. During calibration, illumination 730 from a white light source can be partially absorbed (e.g., absorbing all lights except some remaining light 732, e.g., green) by the optical fiducials 704 and completely reflected by the scintillator (e.g., generating completed reflected white light 734), creating a moderate contrast pattern that can be readily imaged by the camera.

FIG. 8 is a flowchart showing an example of a process 800 to characterize the scintillator blur using a scintillator blur fiducial. A camera blur function is determined 802, e.g., by a processor 124, using an image of at least one optical fiducial. For example, the processor 124 can determine a camera blur function using the measured focus of the camera. A detector blur function is determined 804, e.g., by the processor 124, based on a sharpness of a sharp feature in an image of a scintillator blur fiducial. Because, in general, the detector blur function can be a function of, e.g., a convolution of, the scintillator blur function and the camera blur function, a scintillator blur function can be determined 806, e.g., by the processors 124, based on the detector blur function and the camera blur function. For example, the processor 124 can determine the scintillator blur function by performing a deconvolution operation between the detector blur function and the camera blur function. A future image captured by the camera is deblurred 808, e.g., by the processor 124, based on the scintillator blur function.

FIG. 9 is a flowchart showing an example of a process 900 to characterize a spectrum of the X-ray using a step wedge fiducial. An image of a step wedge fiducial is captured 902, e.g., by the processor 124. A spectrum of the X-rays is characterized 904, e.g., by the processor 124. For example, a change to the spectrum of the X-rays can be detected.

In some implementations, a percent transmission at each of the steps of the step wedge fiducial can be calculated 906, e.g., by the processor 124, using the image of the step wedge fiducial. A reference percent transmission at each of the plurality of steps of the step wedge fiducial calculated during factory calibration can be obtained 908, e.g., by the processor 124. A change to the spectrum of the X-rays can be determined 910, e.g., by the processor 124, by comparing the percent transmission with the reference percent transmission.

A scan configuration, a reconstruction process, or both can be adjusted 912, e.g., by the processor 124, based on the characterized spectrum of the X-rays. For example, the processor 124 can apply beam hardening correction parameters to the radiographs captured by the camera to create corrected radiographs. In some examples, the processor 124 can estimate X-ray scatter and can apply scatter reduction to the radiographs captured by the camera. In some implementations, the characterized spectrum of the X-rays can be fed into an iterative reconstruction algorithm and/or a machine learning model to create an improved reconstruction. In some examples, the processor 124 can adjust a scan configuration, including applying more or less filtering (e.g., at the X-ray source 101), changing source voltage (e.g., in kV) or current (e.g., in uA) (e.g., of the X-ray source 101), changing camera aperture, changing exposure duration (e.g., of the camera 105), any other suitable changes to a scan parameter or setting, or a combination of these.

In some implementations, the step wedge fiducial can also serve as a scintillator blur fiducial. The step wedge can include a sharp feature that has a size below a threshold and the image of the step wedge fiducial captured by the camera can include data representing the sharp feature that is processable to characterize a scintillator blur function of the scintillator. In some implementations, a scintillator blur function of the scintillator can be characterized 914, e.g., by the processor 124, by processing the image of the step wedge fiducial that doubles as a scintillator blur fiducial.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desired results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims.

What is claimed is:

1. An X-ray device comprising:
an X-ray source configured to emit X-rays;
a scintillator configured to absorb, on a first side of the scintillator, the X-rays after interaction with a scan object that has been placed in the X-ray device, the scintillator being configured to emit light from a second side of the scintillator in response to absorption of the X-rays;
a camera configured to receive the light from the second side of the scintillator; and
at least one optical fiducial located on the second side of the scintillator and within a field-of-view of the camera, wherein each of the at least one optical fiducial comprises a sharp feature, which causes an abrupt step change of intensity in reflected light, and an image captured by the camera includes data representing the sharp feature of the at least one optical fiducial that is processable to characterize at least one optical parameter comprising focus of the camera.

2. The X-ray device of claim 1, communicatively coupled with or comprising a non-transitory computer-readable medium encoding instructions configured to cause a processor to perform operations comprising characterizing the focus of the camera using a sharpness of the sharp feature in the image.

3. The X-ray device of claim 2, wherein the camera captures a plurality of images of the at least one optical fiducial over a period of time, and the operations comprise characterizing a change of the focus of the camera over the period of time based on the plurality of images of the at least one optical fiducial.

4. The X-ray device of claim 1, communicatively coupled with or comprising a non-transitory computer-readable medium encoding instructions configured to cause a processor to perform operations comprising characterizing optical geometry of the camera.

5. The X-ray device of claim 1, communicatively coupled with or comprising a non-transitory computer-readable medium encoding instructions configured to cause a processor to perform operations comprising characterizing the focus of the camera and optical geometry of the camera.

6. The X-ray device of claim 1, wherein the at least one optical fiducial is located outside an area of the scintillator that is excited by the X-rays from a maximum scan volume of the X-ray device.

7. The X-ray device of claim 1, wherein the at least one optical fiducial is located on the scintillator, and the scintillator is swappable among a plurality of scintillators to change a property of the X-ray device.

8. The X-ray device of claim 1, wherein the at least one optical fiducial is located on a frame into which the scintillator is inserted.

9. The X-ray device of claim 1, wherein the at least one optical fiducial is a symbol of a symbology type that encodes data of the X-ray device.

10. The X-ray device of claim 9, wherein the data of the X-ray device comprises data of the scintillator, and the X-ray device is communicatively coupled with or comprises a non-transitory computer-readable medium encoding instructions configured to cause a processor to perform operations comprising:
reading, from the image, the data of the scintillator;
determining a type of the scintillator using the data;
characterizing the focus of the camera using a sharpness of the sharp feature in the image; and
in response to characterizing the focus of the camera, making an adjustment to the X-ray device using the type of the scintillator.

11. The X-ray device of claim 1, wherein the X-ray device is communicatively coupled with or comprises a non-transitory computer-readable medium encoding instructions configured to cause a processor to perform operations comprising:
providing second light inside the X-ray device;
capturing, using the camera, the image of the at least one optical fiducial;
measuring the focus of the camera using the image of the at least one optical fiducial;
obtaining a reference focus of the camera;
determining that a difference between the measured focus of the camera and the reference focus of the camera satisfies a threshold;
in response to determining that the difference between the measured focus of the camera and the reference focus of the camera does not satisfy the threshold, performing a calibration of the focus of the camera using the at least one optical fiducial; and
after the calibration, sending an instruction to the X-ray device that causes the X-ray device to scan an object.

12. The X-ray device of claim 1, wherein the X-ray device is communicatively coupled with or comprises a non-transitory computer-readable medium encoding instructions configured to cause a processor to perform operations comprising:
providing second light inside the X-ray device;
setting the camera to two or more different focuses;
capturing, using the camera, a respective image of the at least one optical fiducial for each of the two or more different focuses;
determining a calibrated focus of the camera based on sharpness of the sharp feature in the images captured for the two or more different focuses; and
send the calibrated focus to the X-ray device.

13. The X-ray device of claim 1, wherein the at least one optical fiducial comprises two or more optical fiducials, the X-ray device is communicatively coupled with or comprises a non-transitory computer-readable medium encoding instructions configured to cause a processor to determine a correction for a geometric distortion caused by a change of optical geometry of the camera by performing operations comprising:
providing second light inside the X-ray device;
capturing, using the camera, a current image of the two or more optical fiducials;
obtaining a reference image of the two or more optical fiducials captured during factory calibration;
determining a transformation function, wherein locations of the two or more optical fiducials in a transformed image of the current image under the transformation function match the locations of the two or more optical fiducials in the reference image; and
applying the transformation function to a future image captured by the camera.

14. The X-ray device of claim 13, wherein the at least one optical fiducial comprises three optical fiducials, the transformation function is an affine transformation function.

15. The X-ray device of claim 1, wherein the at least one optical fiducial is placed on the second side of the scintillator and is formed using a wavelength selective material.

16. The X-ray device of claim 15, wherein the wavelength selective material is a material that passes the light emitted from the scintillator and emits light when illuminated with ultraviolet (UV) light, and wherein the second side of the scintillator does not emit light when illuminated with the UV light.

17. The X-ray device of claim 15, wherein the wavelength selective material is a translucent material that passes an emission spectrum of the light emitted from the scintillator, wherein an illumination from a complementary color relative to the emission spectrum is absorbed by the wavelength selective material and is reflected by the second side of the scintillator.

18. The X-ray device of claim 15, wherein the wavelength selective material is a translucent material that passes an emission spectrum of the light emitted from the scintillator, wherein an illumination from a white light source is partially absorbed by the wavelength selective material and is completely reflected by the second side of the scintillator.

19. The X-ray device of claim 1, further comprising:
a scintillator blur fiducial located on the first side of the scintillator and having a second sharp feature that has a size below a threshold, wherein an image of the scintillator blur fiducial captured by the camera includes data representing the second sharp feature of the scintillator blur fiducial that is processable to characterize a scintillator blur function of the scintillator.

20. The X-ray device of claim 19, wherein the scintillator blur fiducial comprises a wire of a metal material.

21. The X-ray device of claim 19, communicatively coupled with or comprising a non-transitory computer-readable medium encoding instructions configured to cause a processor to perform operations comprising:
determining a camera blur function using the image of the at least one optical fiducial captured by the camera;
determining a detector blur function based on a sharpness of the second sharp feature in the image of the scintillator blur fiducial, wherein the detector blur function is a function of the scintillator blur function and the camera blur function; and
determining the scintillator blur function based on the detector blur function and the camera blur function.

22. The X-ray device of claim 19, communicatively coupled with or comprising a non-transitory computer-readable medium encoding instructions configured to cause a processor to perform operations comprising deblurring a future image captured by the camera based on the scintillator blur function.

23. The X-ray device of claim 1, further comprising:
a step wedge fiducial located between the X-ray source and the scintillator and comprising a wedge of a material with a plurality of steps in thickness, wherein an image of the step wedge fiducial captured by the camera includes data representing the wedge with the plurality of steps of the step wedge fiducial that is processable to characterize a spectrum of the X-rays.

24. The X-ray device of claim 23, communicatively coupled with or comprising a non-transitory computer-readable medium encoding instructions configured to cause a processor to perform operations comprising adjusting a scan configuration, a reconstruction process, or both, based on the characterized spectrum of the X-rays.

25. The X-ray device of claim 23, communicatively coupled with or comprising a non-transitory computer-readable medium encoding instructions configured to cause a processor to perform operations comprising:
calculating, using the image of the step wedge fiducial captured by the camera, a percent transmission at each of the plurality of steps of the step wedge fiducial;
obtaining a reference percent transmission at each of the plurality of steps of the step wedge fiducial calculated during factory calibration; and
determining a change to the spectrum of the X-rays by comparing the percent transmission with the reference percent transmission.

26. The X-ray device of claim 23, wherein the step wedge comprises a third sharp feature that has a size below a threshold and the image of the step wedge fiducial captured by the camera includes data representing the third sharp feature that is processable to characterize a scintillator blur function of the scintillator.

27. The X-ray device of claim 1, wherein the at least one optical fiducial comprises a first sharp feature comprising a first abrupt step change of intensity in reflected light and a second sharp feature comprising a second abrupt step change of intensity in reflected light, the image captured by the camera includes (i) data representing the first sharp feature that is processable to characterize a horizontal component of the focus of the camera, and (ii) data representing the second sharp feature that is processable to characterize a vertical component of the focus of the camera.

28. The X-ray device of claim 2, wherein the processor performs the operations between capturing radiographs for a three-dimensional scan of an object.
